(19) United States
(12) Patent Application Publication
(10) Pub. No.: US 2011/0079128 A1
(43) Pub. Date: Apr. 7, 2011

(54) SAW BLADE ELEVATING DEVICE FOR TABLE SAW

(75) Inventors: Chia-Sheng LIU, Taichung County (TW); Fang-Cheng Hsiao, Taichung (TW)

(73) Assignee: DURQ MACHINERY CORP, Shen Kang Hsiang (TW)

(21) Appl. No.: 12/635,791

(22) Filed: Dec. 11, 2009

(30) Foreign Application Priority Data
Oct. 2, 2009 (TW) 98133654

(51) Int. Cl. B23D 47/08; B23D 45/06

(52) U.S. Cl. 83/477.1; 83/508.2

(57) ABSTRACT

A saw blade elevating device for a table saw includes a mounting base, a rotating base pivotally mounted with the mounting base and having two opposite guide slots each extending inclinedly downward, a saw blade unit pivotally mounted with the mounting base and fastened to the rotating base, and a driving unit having a lead screw rotatably inserted in the mounting base, and a guide rod screwed to the lead screw and provided with two ends respectively inserted in the guide slots of the rotating base. When the lead screw is rotated, the guide rod is driven to be moveable between upper and lower dead points of the guide slots of the rotating base for causing a pivotal movement of the rotating base for lifting or lowering the saw blade unit relative to the mounting base.

### BACKGROUND OF THE INVENTION

1. Field of the Invention

The present invention relates generally to a table saw, and more specifically to a saw blade elevating device for a table saw that is used for the purpose of elevating a saw blade unit.

2. Description of the Related Art

FIG. 1 shows a conventional saw blade elevating device 10 for a table saw, comprising a mounting base 12, a rotating base 14 pivotally mounted with the mounting base 12 and provided with two opposite guide slots 142 each extending in a straight manner, a saw blade unit 16 pivotally mounted with the mounting base 12 and fastened to the rotating base 14, and a driving unit 18 having a lead screw 182 rotatably inserted in the mounting base 12 and a guide rod 184 screwed to the lead screw 182 and provided with two ends respectively inserted in the guide slots 142 of the rotating base 14.

According to the aforesaid design, when the lead screw 182 is rotated, the guide rod 184 is moved along an axial direction of the lead screw 182 and pushes periphery walls of the guide slots 142 of the rotating base 14 to cause the pivotal movement of the rotating base 14 relative to the mounting base 12, allowing the saw blade unit 16 to be elevated gradually through the pivotal movement of the rotating base 14. Once the guide rod 184 is moved to an upper dead point of the guide slots 142 of the rotating base 14, the saw blade unit 16 is in an utmost elevation, as shown in FIG.

Since the guide slots 142 of the rotating base 14 each extend in a straight manner, the rotating base 14 is necessary to be pivotally moved with a long stroke for raising the saw blade unit 16 to the utmost elevation, as shown in FIGS. 1 to 2; however, the pivotal stroke of the rotating base 14 is too long to reduce a distance L defined between a pivot joint P to which the mounting base 12 and the rotating base 14 are pivotally connected and an extreme outer edge of the mounting base 12, such that the conventional saw blade elevating device occupies much space.

### SUMMARY OF THE INVENTION

It is one objective of the present invention to provide a saw blade elevating device for a table saw, which can allow a rotating base to be pivotally moved with a short stroke for lifting a saw blade unit to an utmost elevation.

To achieve this objective of the present invention, the saw blade elevating device comprises a mounting base, a rotating base pivotally mounted with the mounting base and having two opposite guide slots each extending inclinedly downward and having an upper dead point and a lower dead point, a saw blade unit pivotally mounted with the mounting base and fastened to the rotating base, and a driving unit having a lead screw rotatably inserted in the mounting base, and a guide rod screwed to the lead screw and provided with two ends respectively inserted in the guide slots of the rotating base. When the lead screw is rotated, the guide rod can be driven to be moveable between the upper and lower dead points of the guide slots of the rotating base for causing a pivotal movement of the rotating base for lifting or lowering the saw blade unit relative to the mounting base.

As indicated above, the pivotal movement distance of the rotating base can be shortened through the descending guide slots for reducing a distance defined between a pivot joint of the mounting base allowing the rotating base to rotate and an extreme outer edge of the mounting base, enabling an increase in usable space within the table saw.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a front view of a saw blade elevating device according to a prior art, showing the saw blade isn't raised;

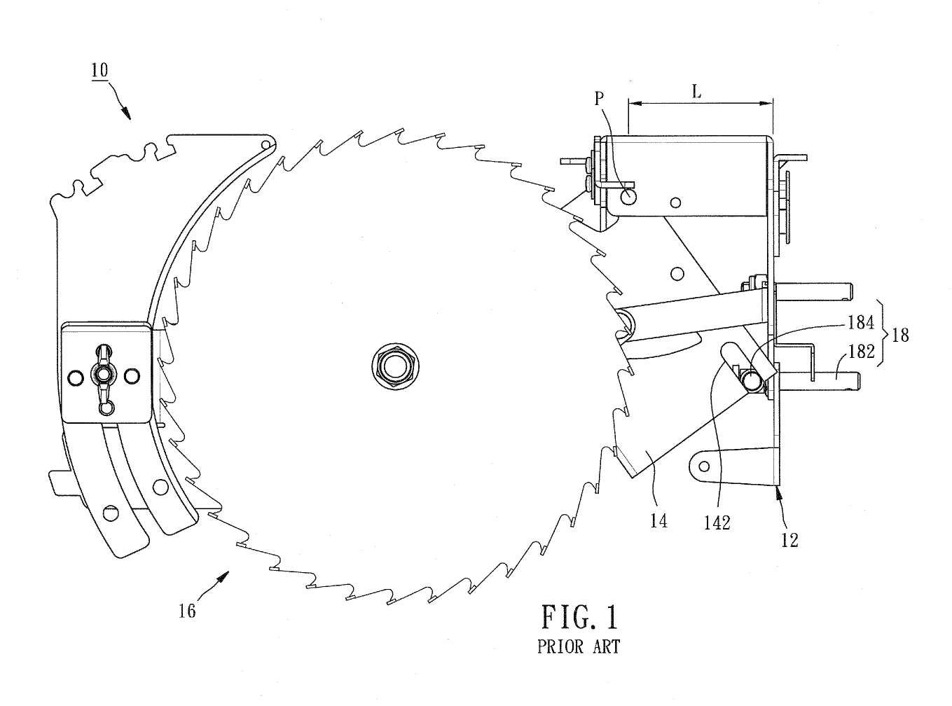

FIG. 2 is another front view of the saw blade elevating device according to the prior art, showing the saw blade is raised to an utmost elevation;

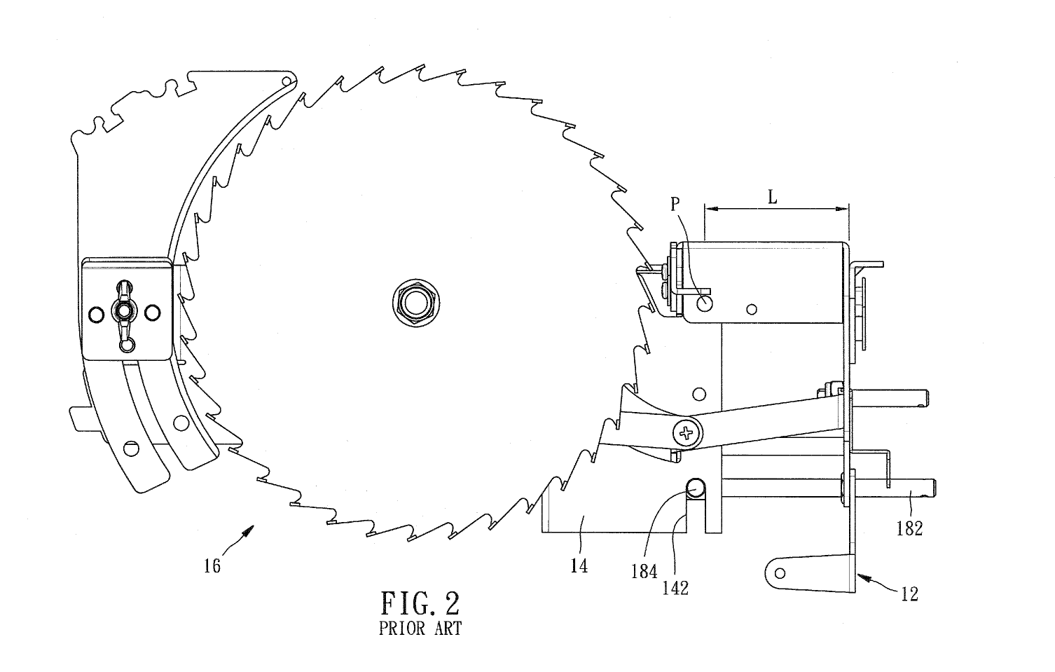

FIG. 3 is a perspective view of a saw blade elevating device according to a preferred embodiment of the present invention;

FIG. 4 is a partially exploded view of the saw blade elevating device according to the preferred embodiment of the prevent invention;

FIG. 5 is a front view of the saw blade elevating device according to the preferred embodiment of the prevent invention, showing the saw blade unit isn't raised;

FIG. 6 is a rear view of FIG. 5;

FIG. 7 is a front view of the saw blade elevating device according to the preferred embodiment of the prevent invention, showing the saw blade unit is raised to an utmost elevation, and

FIG. 8 is a rear view of FIG. 7.

### DETAILED DESCRIPTION OF THE INVENTION

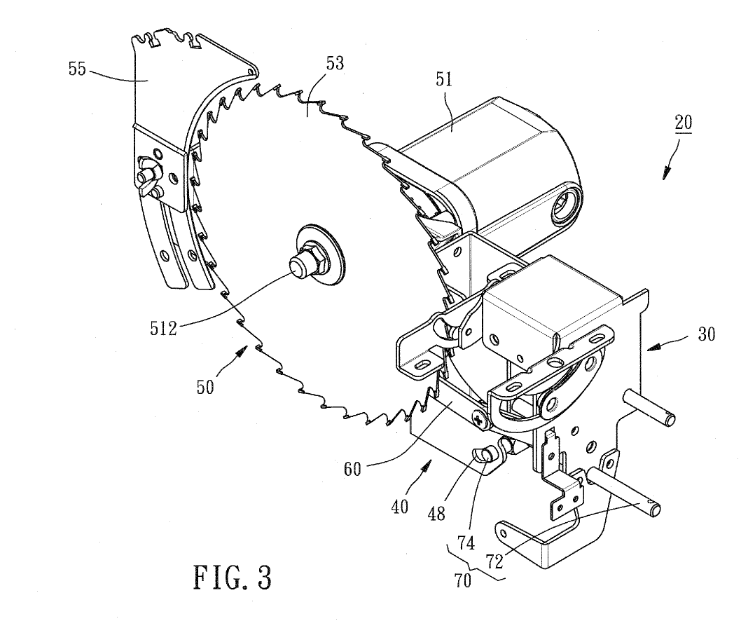

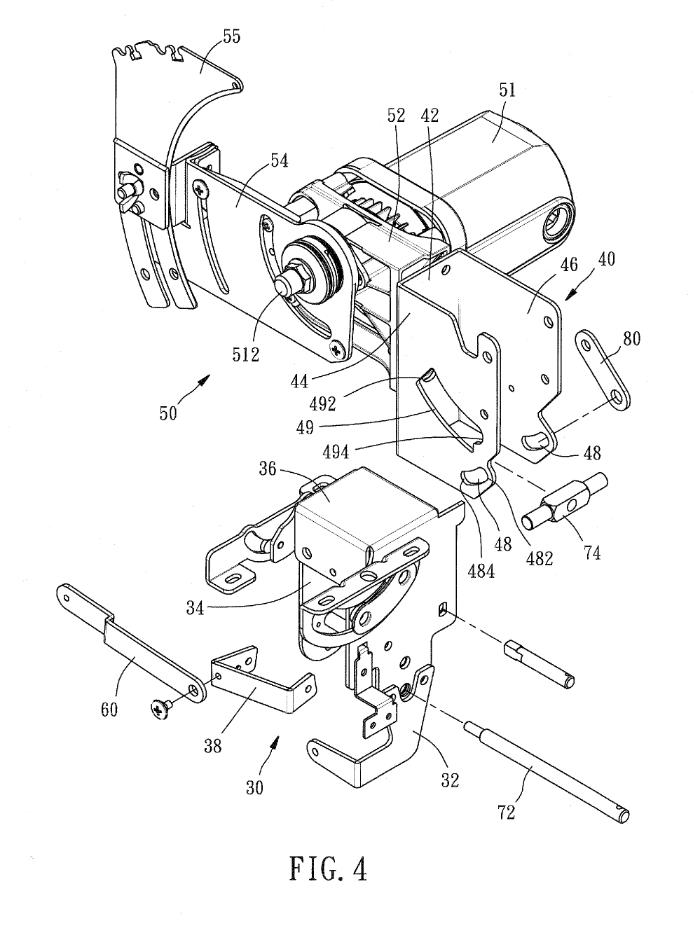

Referring to FIGS. 3 to 4, a saw blade elevating device 20 for a table saw in accordance with a preferred embodiment of the present invention comprises a mounting base 30, a rotating base 40, a saw blade unit 50, a lift rod 60, a driving unit 70, and a link rod 80.

The mounting base 30 has two opposite lateral plates 32 and 34, a top plate 36 connected to the top sides of the lateral plates 32 and 34, and a rib plate 38 fastened to the lateral plates 32 and 34, and located below the top plate 36.

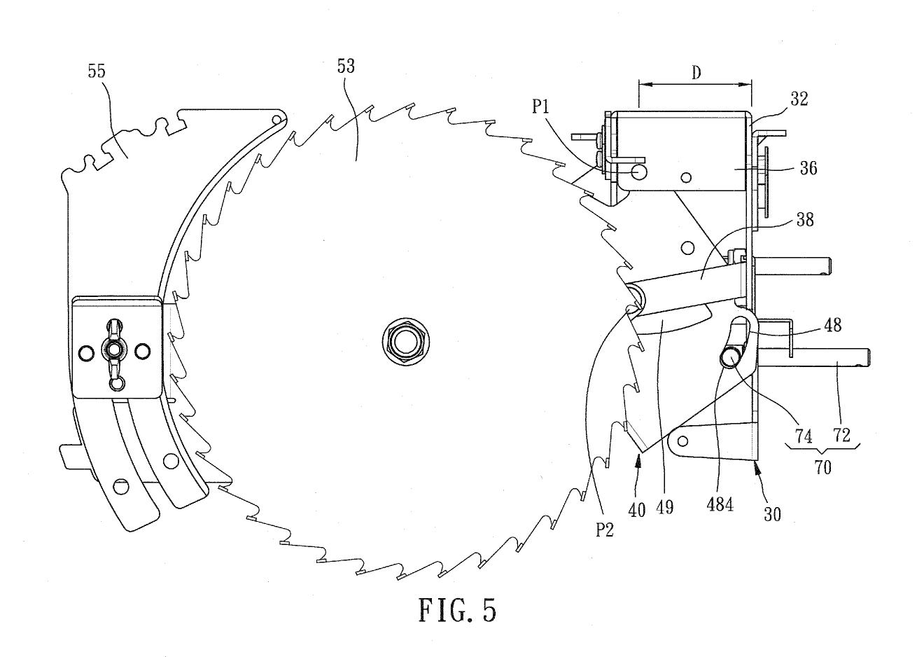

As shown in FIGS. 4 and 5, the rotating base 40 has a connecting plate 42 and two opposite pivoting plates 44 and 46 each integrally extending from one side of the connecting side 42. The pivoting plates 44 and 46 each have a right upper corner pivotally connected with the top plate 36 of the mounting base 30 through a pivot joint P1, and a right lower corner with a curved first guide slot 48 extending downward inclinedly to define a first upper dead point 482 and a first lower dead point 484. Further, the pivoting plate 44 has a curved second guide slot 49 at the middle thereof extending upwards inclinedly to define a second upper dead point 492 and a second lower dead point 494.

The saw blade unit 50 includes a motor 51 having an output shaft 512, a gear box 52 mounted with the motor 51 and having one side fastened to the connecting plate 42 of the rotating base 40, a saw blade 53 rotatably connected to the output shaft 512 of the motor 51 so as to be rotated by the actuation of the motor 51, a spreader bracket 54 pivotally mounted with the output shaft 512 of the motor 51, and a spreader 55 detachably mounted with the spreader bracket 54.

The lift rod 60 has one end fastened to the spreader bracket 54 and the other end pivotally connected with the rib plate 38 of the mounting base 30 through a pivot joint P2 which is moveably located at the second guide slot 49 of the rotating base 40.

The driving unit 70 includes a lead screw 72 rotatably passing through the lateral plate 32 of the mounting base 30 and having a distal end pivotally connected to the lateral plate 34 of the mounting base 30, and a guide rod 74 screwed to the lead screw 72 and having two ends respectively inserted in one of the first guide slot 48 of the rotating base 40.

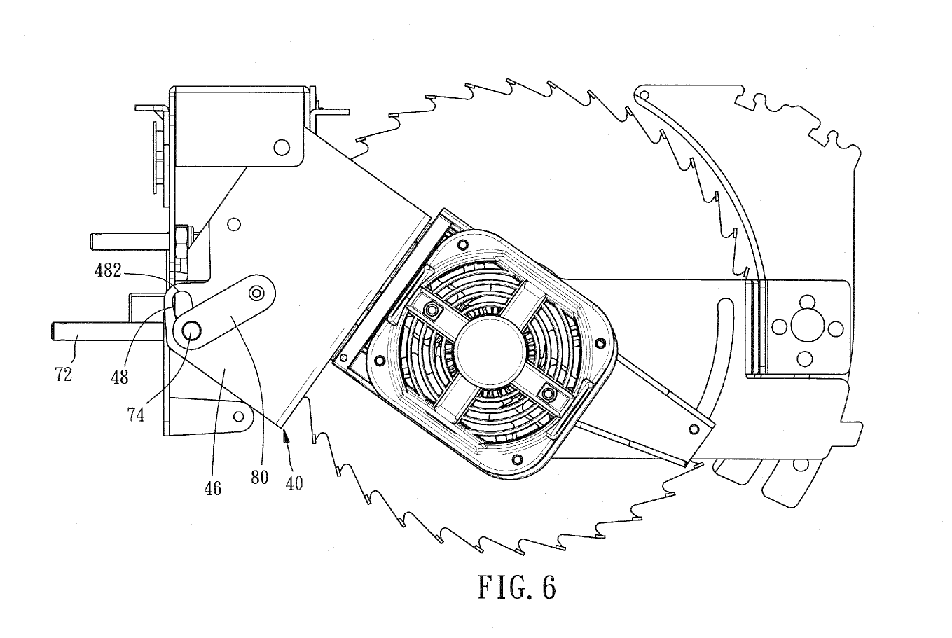

The link rod 80 has one end pivotally connected to the pivoting plate 46 of the rotating base 40, and the other end fastened to one end of the guide rod 74, as shown in FIGS. 4 and 6.

FIG. 5 shows that the guide rod 74 is located at the lower dead points 484 of the first guide slots 48 of the rotating base 40 and the pivot joint P2 is located at the second upper dead points 492 of the second guide slots 49 of the rotating base 40. At this time, the saw blade unit 50 stays at the bottommost elevation.

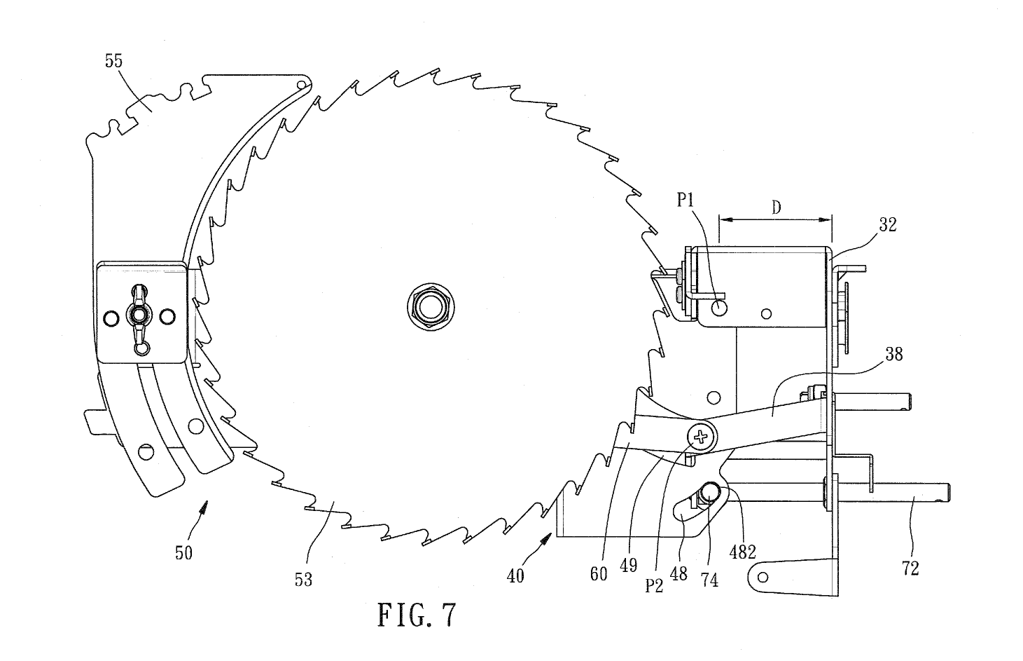

By means of rotating the lead screw 72, the guide rod 74 is moved forwards along an axial direction of the lead screw 72, and then pushes the periphery walls of the first guide slots 48 of the rotating base 40, causing the pivotal movement of the rotating base 40. During the pivotal movement of the rotating base 40, the motor 51 and the saw blade 53 are gradually raised along with the rotation of the rotating base 40, and then the spreader bracket 54 and the spreader 55 are synchronously raised along through the ascent of the motor 51 and the actuation of the lift rod 60. Once the guide rod 74 is moved to the upper dead points 482 of the first guide slots 48 of the rotating base 40, the saw blade unit 50 is raised to an utmost elevation, as shown in FIG. 7, and meanwhile the pivot joint P2 is located at the second lower dead points 494 of the second guide slots 49 of the rotating base 40.

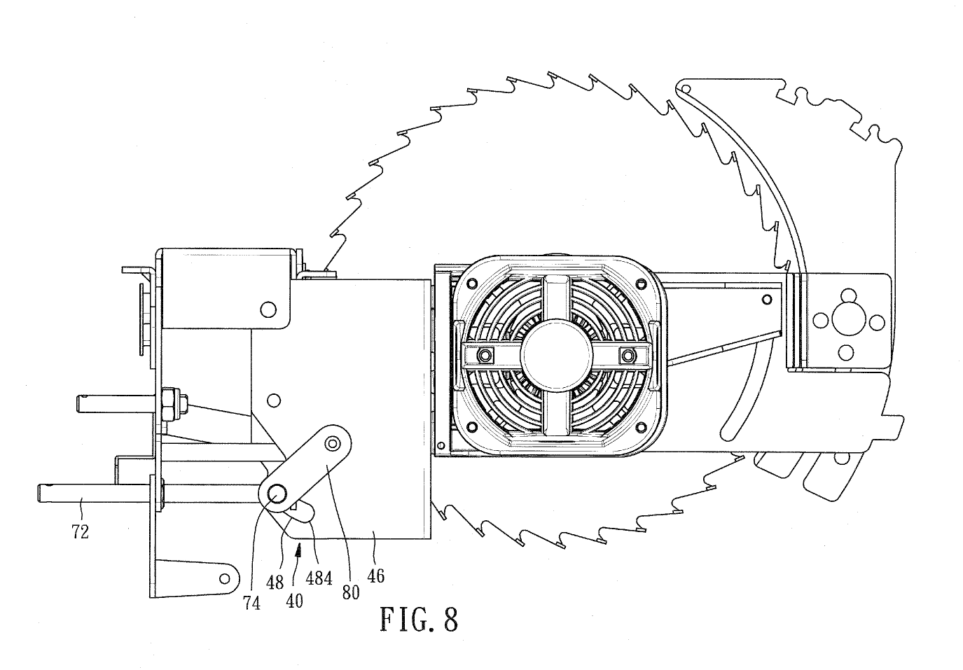

By means of the aforesaid design, since the first guide slots 48 of the rotating base 40 are curved and descending, the pivotal stroke of the rotating base 40, as shown in FIGS. 5 and 7, is shorter than that of the conventional prior art design. Therefore, a distance D defined between the pivot joint P1 and the extreme outer edge of the mounting base 30 can be designed much shorter than the conventional one, such that the saw blade elevating device 20 of the present invention will occupy less space than the conventional one. Further, the guide rod 74 driven by the lead screw 72 can be smoothly moveable between the first upper and lower dead points 482 and 484 of the first guide slots 48, as shown in FIGS. 6 and 8, thanks to the help of the link rod 80.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A saw blade elevating device for use with a table saw, the saw blade elevating device comprising:
a mounting base;
a rotating base pivotally mounted with the mounting base and having two opposite guide slots each extending inclinedly downward and having an upper dead point and a lower dead point;
a saw blade unit pivotally mounted with the mounting base and fastened to the rotating base; and
a driving unit having a lead screw rotatably inserted in the mounting base, and a guide rod screwed to the lead screw and provided with two ends respectively inserted in the guide slots of the rotating base such that the guide rod can be driven by the rotation of the lead screw to be moveable between the upper and lower dead points of the guide slots of the rotating base for causing a pivotal movement of the rotating base relative to the mounting base to lift or lower the saw blade unit relative to the mounting base.

2. The saw blade elevating device as claimed in claim 1, wherein each of the guide slots of the rotating base has a curved shape.

3. The saw blade elevating device as claimed in claim 2, further comprising a link rod having one end pivotally mounted with the rotating base and the other end fastened to the guide rod of the driving unit.

4. The saw blade elevating device as claimed in claim 1, further comprising a lift rod having one end pivotally mounted with the mounting base and the other end fastened to the saw blade unit.
